(19) United States
(12) Patent Application Publication
(10) Pub. No.: US 2018/0325079 A1
(43) Pub. Date: Nov. 15, 2018

(54) FEEDING PLATTER FOR PETS

(71) Applicants: Carol Smeja, Chicago, IL (US); Robert Banning, Chicago, IL (US)

(72) Inventors: Robert Gailen, (US); Carol Smeja, Chicago, IL (US); Robert Banning, Chicago, IL (US)

(21) Appl. No.: 15/977,058

(22) Filed: May 11, 2018

Related U.S. Application Data
(63) Continuation-in-part of application No. 14/854,843, filed on Sep. 15, 2015, now abandoned.
Application No. 14/854,843 is a continuation-in-part of application No. 14/286,532, filed on May 23, 2014, now abandoned.

(51) Int. Cl. A01K 5/01; A47J 47/00

(52) U.S. Cl. CPC A01K 5/0135; A47J 47/005

(57) ABSTRACT

The present invention provides a feeder having an open, planar feeding surface to present a variety of foods to pets such as dogs or cats. The feeder is made of a cellulosic composite dual phase material that facilitates the cutting of various foods without dulling cutting implements and may be easily cleaned and sanitized in a dishwasher or by hand. The present invention allows for the presentation to pets of a variety of foods that may be cut, spread or dispersed on the surface allowing the juices, gravies or applied foods to fill an array of indentations and grooves in the feeding surface.

### REFERENCE TO PRIOR APPLICATION

This application claims priority from U.S. Design patent application Ser. No. 29/485,178, filed 17 Mar. 2014, now U.S. Design Pat. No. D717,504, and is a continuation in part of co-pending U.S. utility application Ser. No. 14/854,843, filed 15 Sep. 2015, which is a continuation in part of U.S. utility application Ser. No. 14/286,532, filed 23 May 2014.

### BACKGROUND OF THE INVENTION

### Field of the Invention

The present invention relates to a pet feeding device and in particular to a pet feeding environment where food is placed in such a manner as to permit pets to engage in instinctive feeding behavior during their consumption of food.

### Description of the Prior Art

Domesticated dogs and cats are not able to thoroughly experience their natural feeding behavior while consuming food from a vessel such as a bowl. Eating from a bowl presents complications such as bloat due to rapid food consumption and swallowing air. Depending on the height of the bowl sides, the pet's vision of its surroundings may be obstructed.

Feeding bowls or feeding vessels are generally single cavity concave containers that contain the entire contents of a meal. Consuming food from a bowl or feeding vessel confines dogs and cats to the singular activity of eating a complete serving in its entirety, often as rapidly as possible. This activity is perfunctory and does not give the dog or cat the opportunity to become emotionally engaged in its feeding experience.

Feeding apparatuses of the prior art include various designs to deliver food to pets. These devices may challenge the pet's interaction with food; parcel out limited quantities of food; engage the pet in locating food; and slow the speed of consuming food. These feeding apparatuses share the commonality of confining a food serving in a single cavity or trough.

They may often lead to a dog or cat becoming frustrated or anxious during the feeding activity. Feeding apparatuses of the prior art include a pan for collecting spilled food for disposal at a later time. Thus, in a device in accordance with U.S. Pat. No. 4,532,891, spilled food cannot be consumed by the pet because the food falls through a lattice and is allowed to remain in a pan below the feeding bowls and away from the pet for an extended period of time.

U.S. Pat. No. 4,532,891 discloses a pet feeder assembly characterized by a substantially rectangular pan, an open lattice member engaged with the sidewalls of the pan, and a pair of feeding bowls engaged with apertures provided through the lattice member. The lattice member has interstices large enough to permit water, kibble and other large size particulate matter to fall into a collection pan.

U.S. Pat. No. 2005/0115508 discloses an elevated pet feeder with removable easily cleaned food and water containers which fit into a table platform structure of a pet-specific size and shape made of natural wood material of a heavy weight with heavy legs to hold the feeder in place while the pet eats and drinks. The elevated table surface supports removable bowls, which enable the pet's neck to be positioned adjacent to the bowl, food and water containers.

U.S. Pat. No. 4,907,539 discloses a combination pet feeder consisting of a divided food and water bowl centered and anchored on a flat and colorful rubber mat. The mat catches all spillages while the dog feeds. The bowl stays in position at all times.

U.S. Pat. No. 7,040,252 discloses a pet feeding device for holding a commercially available disposable paper plate. The device comprises a tray base with four molded integral hooks. The paper plate is slid in place under three of the four hooks and snapped in place under the fourth hook to secure it in place. The tray base prevents food displaced from the plate by the feeding animal from falling on the floor. The paper plate is disposed of after use. The tray base is made of plastic or similar material that is easily washable by hand or in a dishwasher.

U.S. Published Application No. 2013/0305996 discloses a tray for presenting food to a pet or animal. The tray includes a top side, an underside and a peripheral side extending between the top side and the underside. The top side defines a series of interconnected grooves resembling troughs that traverse the tray.

U.S. Pat. No. 7,178,798 discloses a cutting board comprising a top surface and a bottom surface. The top surface is bounded by a raised edge curvlinearly extending into a channel encompassing a planar work surface. At one end, fluid and food in the channel pools into a reservoir having a spillway with a lip extending sconce-like and coplanar with the raised edge forming a spout. The bottom side is notched to serve as a handhold opposing the spout. The work surface recess that serves to decrease mass is ribbed by a lattice of intersecting walls providing a light-weight product while substantially increasing the work surface load capacity.

U.S. Pat. No. 8,534,225 and continuation U.S. Pat. No. 8,844,466 disclose an animal feeding system allegedly for slowing the eating process of an animal, e.g., a dog, and simultaneously entertaining the animal. The animal feeding system includes a floor, or mat, from which upwardly protruding retaining walls and obstacles form a maze. The obstacles may vary, for example, in shape (e.g., as letters, words, geometric shapes, etc.), form (e.g., rigid structure, flexible fingers, etc.), size, height, etc. In addition, the upstanding obstacles may include structures asserted to further slow an animal's eating, such as tunnels, slides, ramps, etc. The animal feeding system may be fabricated of material including, but not limited to, silicone rubber, natural rubber, metal and ceramic.

Feeding apparatuses of the prior art rely on a plurality of obstacles and troughs that confine food to a maze that challenge the pets ability to retrieve food in order to slow the feeding process. Thus, in a device in accordance with U.S. Pat. No. 8,534,225 and continuation U.S. Pat. No. 8,844,466, the obstacles are much like a closed kitchen where food cannot be seen versus an open concept feeding arena which provides a clear view across and beyond the feeding surface.

### OBJECTS OF THE INVENTION

An objective of the present invention is to give a dog or cat a feeder which gives the animal the opportunity to see an entire serving of food at one time, which engages the animal's instinctive eating behavior while it consumes the food. The present invention provides an arena reminiscent of a preferred location of an animal's prey where the feeding environment provides an opportunity for the pet to navigate the surface to its liking while providing the pet with an unobstructed view of its surroundings. This novel feeder permits the pet to comfortably scoop food from an array of shallow indentations and from a shallow groove surrounding the table surface. The pet can eat food resting on the feeder surface or lick the surface until the pet is satisfied or all the food has been consumed.

A second objective is to provide a feeding surface resembling a more natural feeding environment than that provided by the prior art. This allows the pet to explore and experience the challenge of digging and licking with its tongue during an extended feeding period. This feeding method regulates food consumption while inducing increased licking that encourages the release of endorphins which serve to relax and satisfy the pet. Furthermore, the expanse of the unobstructed feeding surface naturally slows the feeding process providing a surprisingly satisfying and beneficial eating experience for the pet. This feeder presents no obstacles to the pet's vision. Obstacles slow the feeding process, which leads to pet frustration and anxiety. The feeding surface is primarily cellulosic fiber which is very different from known feeders.

A third objective of the present invention is to allow a dog or cat to observe both its prized resource of food and the environment surrounding its feeding area. This feeding area and the food located there imitates newly acquired prey, and enables the dog or cat to engage in a relatively leisurely meal without engaging its resource protection instincts that may compel the dog or cat to rush through the feeding process.

An advantage of the present invention gives the pet owner the ability and convenience of assembling a variety of meal constituents needing to be cut or chopped to an appropriate size without the need to transfer the cut or chopped food to another feeding apparatus or container. This leaves the cut food and remaining liquid or gravy on the invention embodiment surface to be consumed by the dog or cat.

A further advantage of the present invention is that a variety of food types may be cut, smeared, poured or placed on the surface of the invention and pushed into the indentations for the enjoyment of the dog or cat.

A still further advantage of the present invention is that the cutting surface will not dull cutting implements during normal use and may be washed by hand or in a dishwasher.

Yet another advantage of the present invention is that the bottom surface may be used as a cutting surface that will not dull cutting implements during normal use.

Another advantage of the present invention is the absence of protrusions or removable devices that can be accessed by a pet and mutilated or ingested.

Yet another advantage of the present invention is that it may be used by dogs or cats regardless of the dog or cat's anatomy.

Still another advantage of the present invention is that it is made from a non-toxic material that is extremely durable, scratch and bite resistant, recyclable and available in a variety of colors.

### BRIEF DESCRIPTION OF THE DRAWINGS

These and other advantages and details of our invention will be described in connection with the accompanying drawings, which are furnished only by way of illustration and not in limitation of the invention. In the drawings:

FIG. 1 is an isometric view of a small bone shape feeder with a dog looking over it.

FIG. 2 is an isometric view of a large bone shape feeder with a dog looking over it.

FIG. 3 is an isometric view of the bottom of a bone shape feeder.

FIG. 4 is an isometric view of the bottom of a bone shape feeder with a ribbon of non-skid material surrounding the perimeter of the invention.

FIG. 5 is a cutaway isometric view showing feeder indentations in the surface of the invention.

FIG. 6 is a cutaway isometric view showing a raised edge and channel that surround the periphery of the invention.

FIG. 7 is an isometric view showing food being cut on the surface of the invention.

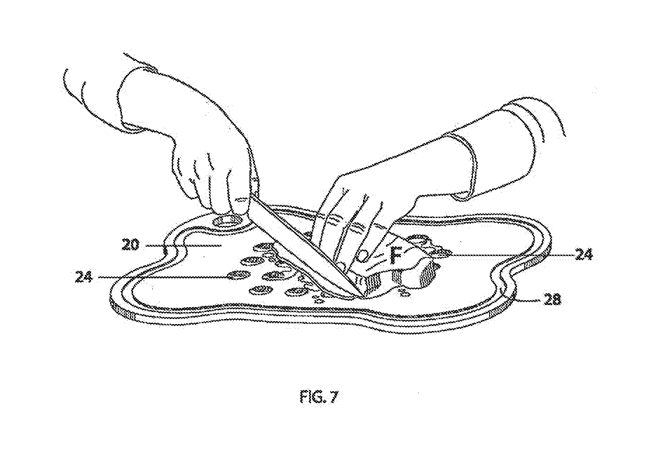

FIG. 8 is an isometric view showing a dog licking the surface of the invention.

FIG. 9 is a cutaway isometric view showing a dog's tongue within an indentation of the invention.

FIG. 10 is a cutaway isometric view showing food on a dog's tongue being lifted out of an indentation.

FIG. 11 is a top plan view of a fish shaped feeder embodying the present invention.

FIG. 12 is a top plan view of a round shaped feeder embodying the present invention.

FIG. 13 is a top view of a quadrilateral shaped feeder having rounded corners embodying the present invention.

FIG. 14 is a top plan view of a bone shaped feeder embodying the present invention.

### DETAILED DESCRIPTION AND BEST MODE FOR CARRYING OUT THE INVENTION

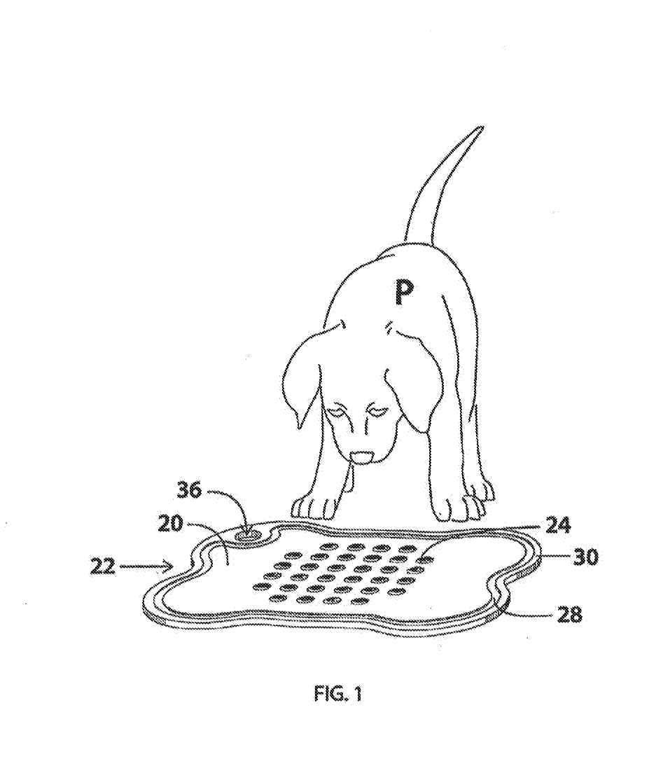

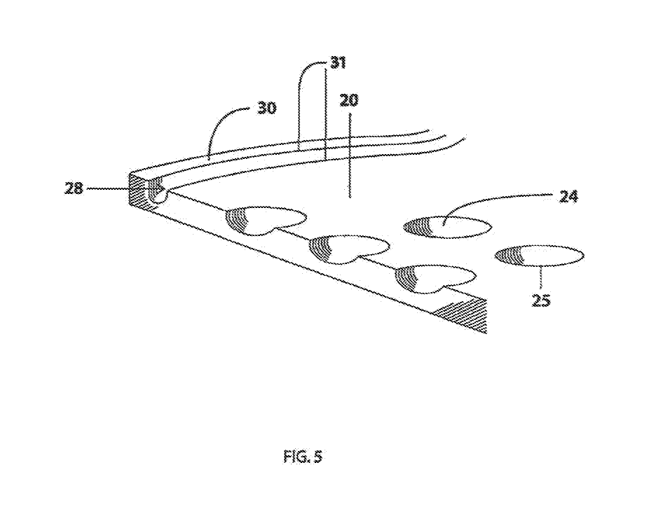

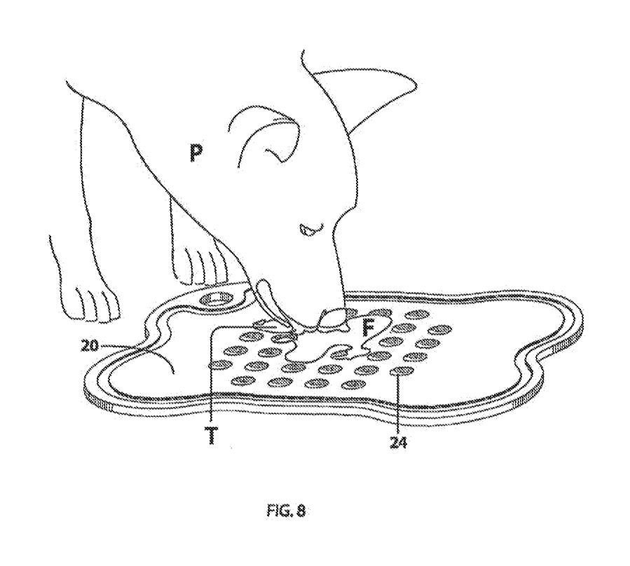

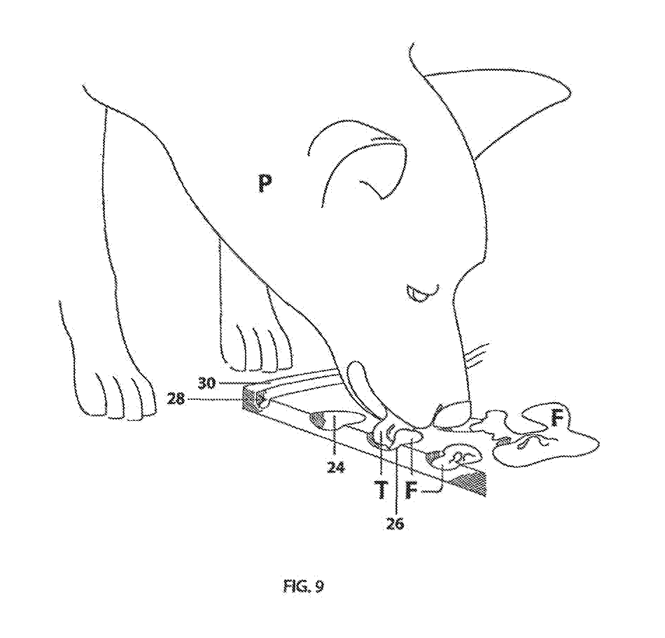

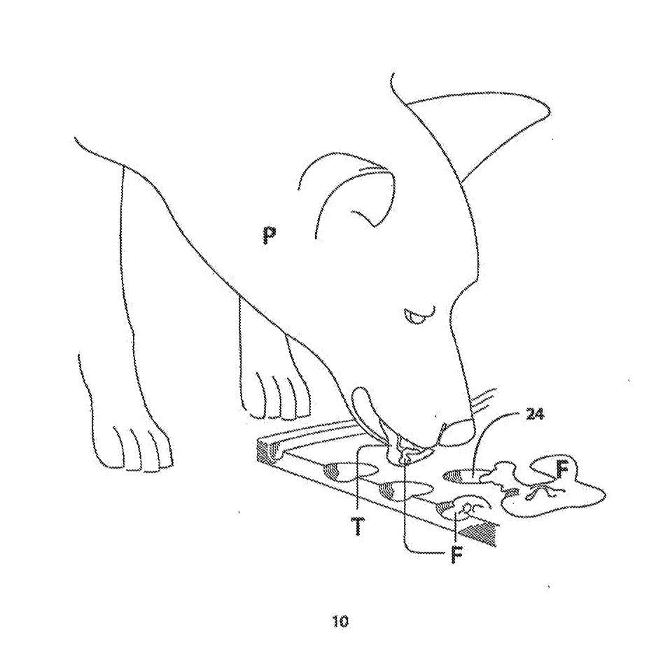

To accomplish the objectives and provide the advantages of the invention described above, we provide a pet feeder 22 here embodied as an obstacle free, legless unitary slab or tablet upon which can be placed food F for the pet P, as shown in FIGS. 1-5 and elsewhere. To encourage the pet P to engage the food in accordance with the pets' natural eating skills and consumption habits, the upper surface 20 of the feeder 22 is a generally planar and unobstructed open feeding surface, but that surface 20 presents multiple regularly-patterned indentations. As shown in FIGS. 5, 6, 9 and 10, theses indentations 24 are preferably semi-spherical indentations with rounded edges 25. In accordance with one aspect of the invention and as illustrated sequentially in FIGS. 8, 9 and 10, these indentations 24 are of a size and shape sufficient to receive food F and to retain that food therein as the pet engages the food with its tongue T. The pet P then presses the food between its tongue T and a wall 26 of the indentation, in accordance with its natural eating habits. In further accordance with natural eating skills and habits, the pet P then lifts the food F its tongue T from the indentation 24 into the pet's mouth to consume the food. The open feeding surface allows a pet's snout of whatever size or shape to access the surface and indentations without interrupting protrusions or maze-like structures.

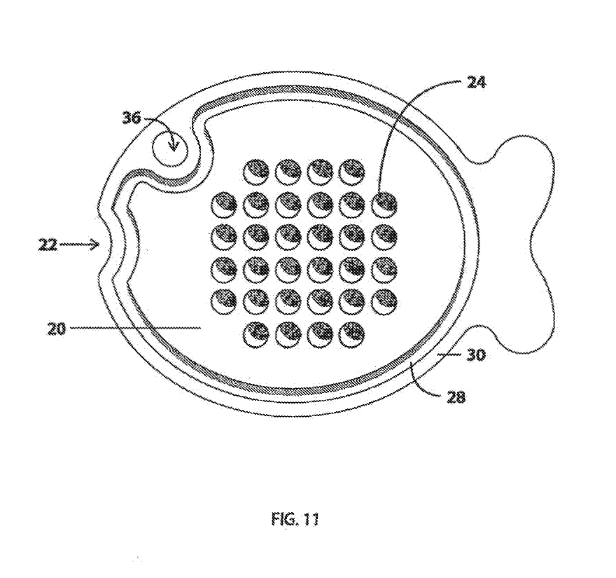

In accordance with the invention, as shown in FIGS. 11-14, the feeder top surface 20 and the indentations 24 resemble, in some functional ways, the natural feeding environment of a dog or cat. This partially replicates the environment of the pet's ancestors (and, possibly, the pet itself) so as to encourage the pet to employ its instinctual feeding behavior in the consumption of the food. This arrangement allows for the pet to experience the challenges of digging and licking with its tongue during an extended feeding period. This extended feeding experience encourages, in turn, the release of endorphins during the food consumption and licking process, and the endorphin release and general experience may serve to relax and satisfy the pet. Because there are no feeder walls or obstructions the feeder is compatible with any size or type of pet.

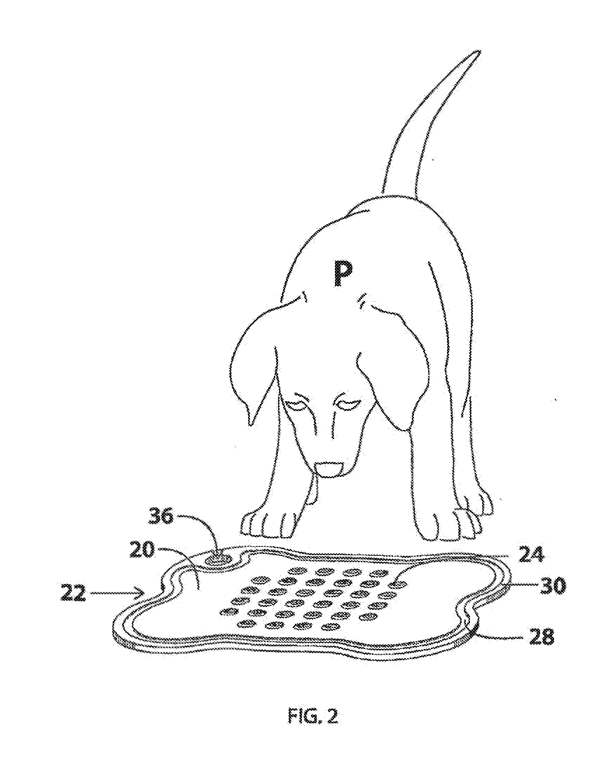

It will be understood that the novel feeder may be manufactured and offered in a variety of sizes and shapes, and the indentations 24 may be provided in a variety of sizes and shapes and array formations. As suggested in FIG. 1, relatively small and shallow indentations can be provided in feeders designed for use by, for example, kittens, puppies and small dogs and cats. Larger feeders having deeper, wider indentations which are spaced farther apart from one another can be offered for use by mature pets and larger animals as suggested in FIG. 2.

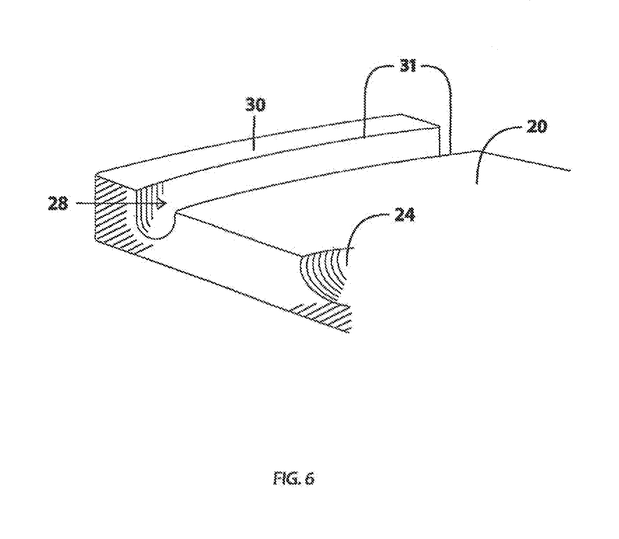

In accordance with another aspect of the invention, the edge of the feeder 22 is here formed or otherwise provided with a trough 28 and a raised edge or rim 30 having a rounded edge 31, as shown in FIGS. 5 and 6. These arrangements or formations are of a height, depth, size and shape to prevent, or at least inhibit, food and liquids from being lost from the feeder and escaping onto a floor or other inconvenient surface. Again, the exact size and shape of the groove 28 or trough and the raised edge or rim 30 are selected to be of maximum effectiveness for the intended pet user and maximum attractiveness to the pet owner or caregiver. Preferably rounded edges 31 shown in FIG. 5 and FIG. 6 are provided to minimize damage to food preparation instruments and discomfort to the pet and pet caregiver.

In accordance with another aspect of the invention, this feeder tablet or slab can be manufactured by injection molding or other appropriate process from food grade thermoplastic. In a preferred embodiment of the invention, that plastic can be a dual continuous phase cellulosic composite. The material can be selected from a group of materials approved by the US Department of Agriculture, the National Safety Foundation, and the US FDA. The plastic material can include fibrous constituents extracted from trees grown and sustainably managed forests.

There particularly, the preferred material is a cellulosic composite designated as THRIVE 15DXV2355 SCAN available from the International Paper Company having offices in Memphis Tenn. This cellulose fiber composite material has the characteristic shown on the attached data sheet.

The pet feeding platter made from this cellulose composite material has a surprisingly great number of advantages. It has antibacterial properties, and it is resistant to or impervious to sterilization by heat and/or sterilizing fluids. The constituent material is not harmful to pets, humans or the environment, and the feeder is dishwasher safe. The pet platter is heavy enough to effectively resist being pushed across the floor or other planar service by an enthusiastic and hungry pet if an appropriate non-skid underlayment is used between the feeder and the floor. It is extremely durable in comparison with objects made from polypropylene or other such materials. The platter is comparatively stiff, and comparatively tough; The Pet platter is hard to crack or fracture under normal usage conditions. It is not biodegradable in any way. It has a soft feel to the human hand and to the animal's tongue.

This combination of attributes cannot be achieved by manufacturing a pet platter in any other known form of polypropylene, polyethylene, EVA or other thermoplastics commonly used in consumer products.

The pet platter made of this THRIVE 15DXV2355SCAN material includes approximately 15% ultra-pure cellulose fiber, which is broadly understood to be the most common organic material among all plants, trees, bushes and related sustainable agricultural sources. The presence of these highly pure cellulose fibers on the pet platter surface is a key differentiating factor of this material, and the platter made from this material, as compared to platters or feeders made from any other plastics or materials.

The manufacture of pet platters made from this material is surprisingly quick and effective. The platters can be manufactured by injection molding at relatively low cost using relatively cool temperatures and in less than half the time required to injection mold similar articles. The pet platters made from this material do not warp; the upper and lower services of the platter are extremely flat. The platters will have an extremely long service life. They have a high heat deflection temperature, and a high modulus of elasticity; they are stiff. They are relatively soft to the touch. They do not soak up water. They are resistant to household chemicals.

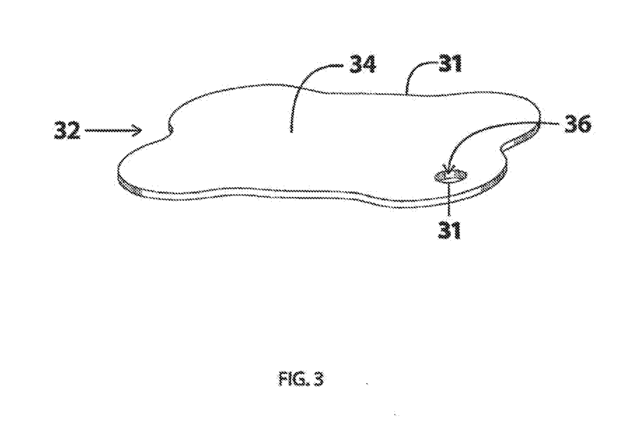

Another aspect of the invention is illustrated in FIG. 3, which shows the reverse side or bottom 32 of the feeder 22. The surface 34 is planar, has a rounded edge 31, and without indentations, and it can be used as a cutting board for preparing food for the pet or any other suitable material. The THRIVE cellulosic composite material contemplated here is substantially impervious to cutting or damage by kitchen knives or other common food utensils.

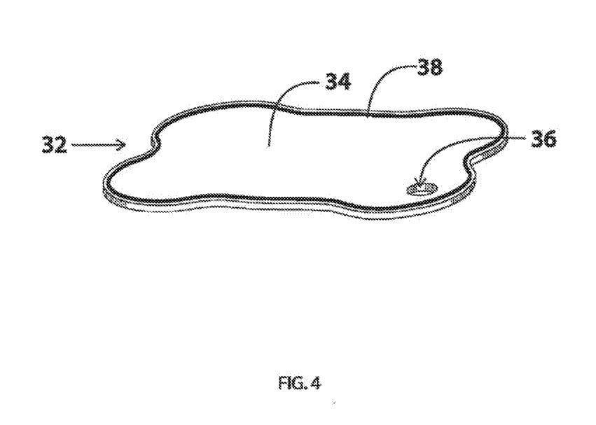

An additional aspect of the invention is illustrated in FIG. 4, which shows the optional addition of a thin ribbon of non-skid material 38 surrounding the bottom 32 of the feeder 22 preferably at the edge of the perimeter of the feeder 22.

In accordance with another aspect of the invention, food can be prepared for the pet directly on the upper or serving surface, as illustrated in FIG. 6. Juices or small particles resulting from the cutting process on the top surface of the board will collect in the indentations 24 on the top 20 and in the grooves 28 which surround the feeder top surface cutting area.

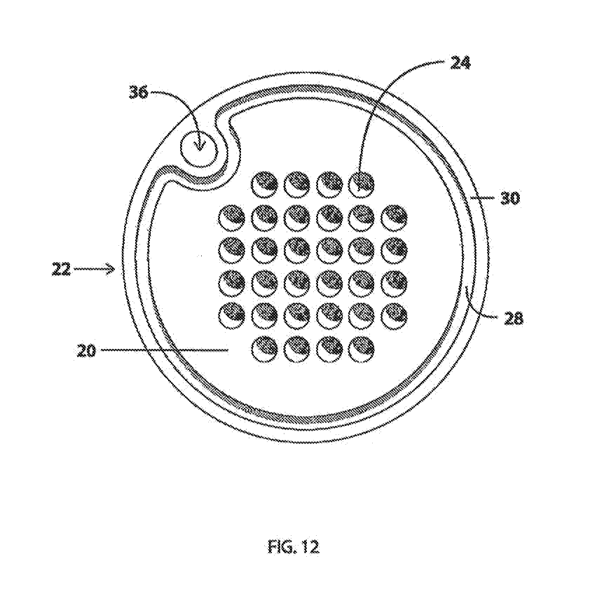

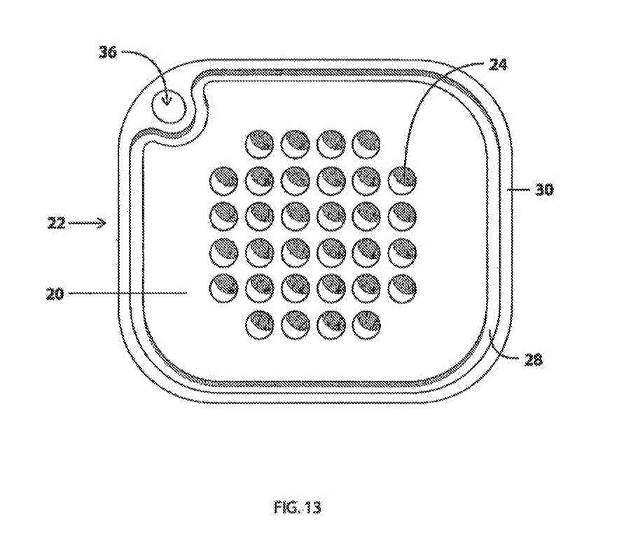

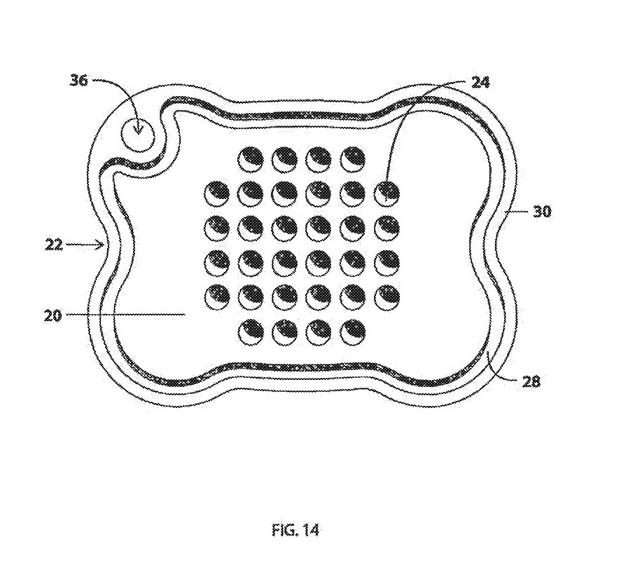

As illustrated in FIGS. 1 and 11, the pet feeder can be sized and shaped to suggest the appearance of an object selected from a group of objects which are familiar and attractive to pet owners. For example, the feeder shown in FIG. 1 has a size and shape suggestive of a bone attractive to dogs and dog owners. The feeder shown in FIG. 11 has a shape suggestive of a fish attractive to cats and cat caregivers. These and other shapes can be recognized by the pet and the pet owner as belonging specifically to that pet. Other, relatively abstract, shapes such as circular discs of a shape similar to the shape shown in FIG. 12, and generally rectilinear shapes of the sort shown in FIG. 13, may also be commercially attractive. The feeder shown in FIG. 14 has a shape suggestive of a bone attractive to dogs and dog caregivers.

If desired, the feeders may be formed or otherwise made with one or more through holes 36 to permit the feeder to be hung on a convenient hook. If desired, the through hole 36 can be sized and positioned to act as a thumb-hole for ease of feeder manipulation.

Observations of a variety of dog and cat breeds, weights and physical size which are fed from the present invention indicate a surprising, dramatic and remarkable change in the animals' eating behavior. These pets appear to be more relaxed while they eat and they eat at a much slower pace. An association by the pet to the shape of the invention has elevated their excitement prior to each feeding. Pets explore the surface of the invention choosing food from various indentations interspersed with extended licking, moving around the invention all while continuously observing their surroundings.

It will be understood by those skilled in the art that various modifications can be made to the embodiments of the invention described and illustrated here without departing from the spirit and scope of the invention as defined by the appended claims.

We claim as invention:

1. A pet feeder made of THRIVE material.

2. A pet feeder according to claim 1, herein said material is THRIVE DXV2355SCAN material.

3. A pet feeder according to claim 1 and comprising a generally planar surface, said surface having a plurality of indentations being of a shape sufficient to receive food for a pet and retain the food therein as the pet engages the food with its tongue and presses the food between its tongue and the wall of the indentation and thereafter lifts the food from the indentation to consume it, wherein said planar and unobstructed surface is open and free of protruding obstacles, impediments and barriers.

4. A pet feeder according to claim 1 and having an open planar feeding surface presenting multiple regularly-patterned indentations.

5. A pet feeder according to claim 4 wherein said planar surface has unobstructed indentations which sized and shaped to receive and retain food.

6. A pet feeder according to claim 1 wherein said planar surface is an open, unobstructed feeding surface that allows a pet's snout of whatever size or shape to access the surface and indentations without interrupting protrusions or maze structures.

7. A pet feeder according to claim 1 wherein said feeder is constructed as a single slab of THRIVE free of protrusions or impediments that restrict a pets' consumption of food.

8. A pet feeder according to claim 1 wherein said surface is provided with an endless raised rim of sufficient height to inhibit the loss of food from the surface.

9. A pet feeder according to claim 1 wherein said surface is provided with an indented groove of sufficient depth to inhibit the loss of food from the surface.

10. A pet feeder according to claim 1 made by injection molding.

11. A pet feeder according to claim 1 having a flat surface uninterrupted by depressions that can be used as a cutting board.

12. A pet feeder according to claim 1 wherein the appearance of said feeder is similar to the silhouette of an object selected from a group of objects familiar and attractive to pet owners.

13. A pet feeder according to claim 1 wherein said table is formed of a material that is not harmful to pets, humans or the environment.

14. A pet feeder according to claim 1 wherein said table is formed of a material that is dishwasher safe.

15. A pet feeder according to claim 1 wherein said indentations are of a size and shape generally related to the size and shape of the tongue of the pet expected to use the feeder.

16. A pet feeder made at least partially of a dual phase cellulosic composite material having antibacterial properties and being resistant to sterilizing fluids.

17. A pet feeder according to claim 15 having an upper open, unobstructed planar feeding surface provided with an array of food-receiving receptacles.

18. A pet feeder according to claim 15 having a planar cut-resistant surface.

19. A pet feeder according to claim 15 made of material having at least some of the characteristics of THRIVE material.

20. A pet feeder formed of a dual continuous phase cellulose fiber-based composite having a top planar unobstructed surface, said surface defining a plurality of indentations each being of a shape to receive food for a pet and to retain that food as the pet engages the food and presses the food between its tongue and the wall of the indentation to thereafter lift the food from the indentation, the upper unobstructed surface allowing a pet's snout to access the indentation without encountering interrupting protrusions, the pet feeder further having a bottom planar unobstructed surface.

21. A pet feeder according to claim 20 wherein said bottom surface is adapted to be used as a cutting board and is resistant to cutting board knife.

22. A pet feeder according to claim 16 made of a material having the characteristics of THRIVE 15DX2355SCAN.
